(19) United States
(12) Patent Application Publication
(10) Pub. No.: US 2025/0165668 A1
(43) Pub. Date: May 22, 2025

(54) WEIGHT COEFFICIENT CALCULATION DEVICE AND WEIGHT COEFFICIENT CALCULATION METHOD

(71) Applicant: NEC Corporation, Minato-ku, Tokyo (JP)

(72) Inventor: Yuta IDEGUCHI, Tokyo (JP)

(73) Assignee: NEC Corporation, Minato-ku, Tokyo (JP)

(21) Appl. No.: 18/841,728

(22) PCT Filed: Apr. 22, 2022
(86) PCT No.: PCT/JP2022/018589

§ 371 Date: Aug. 27, 2024

(51) Int. Cl. G06F 30/20; G06F 111/06; G06F 111/10

(52) U.S. Cl. CPC G06F 30/20; G06F 2111/06; G06F 2111/10

(57) ABSTRACT

Each constraint term in an expression representing energy in a combinatorial optimization problem is input the input means 71. The automatic establishment rate calculation means 73 calculates an automatic establishment rate for each constraint term, wherein the automatic establishment rate is a probability that a constraint represented by a constraint term is satisfied when all other constraints associated with individual spins associated with the constraint term are satisfied. The energy increase amount determination means 74 determines amount of energy increase at constraint breakdown for each constraint term, wherein the amount of energy increase at constraint breakdown is amount of energy increase when a constraint represented by a constraint term is no longer satisfied. The spin number derivation means 75 derives the number of spins associated with a constraint represented by a constraint term, for each constraint term.

### TECHNICAL FIELD

The present invention relates to a weight coefficient calculation device, a weight coefficient calculation method, and a computer-readable recording medium containing a weight coefficient calculation program, for calculating a weight coefficient of each constraint term in an expression representing energy in a combinatorial optimization problem.

### BACKGROUND ART

An energy function of the Ising model or QUBO (Quadratic Unconstrained Binary Optimization) is used in solving combinatorial optimization problems.

The Ising model is a statistical mechanical model that represents the behavior of a magnetic material by individual spins, and is also applicable to solving combinatorial optimization problems. In the Ising model, the states of individual spins are represented by “1” or “−1”.

The energy function of the Ising model is expressed as in expression (1) below.

$$[ Math . 1 ]$$

$$E = {\sum }_{i} {\sum }_{j} {J}_{ij} {s}_{i} {s}_{j} + {\sum }_{i} {h}_{i} {s}_{i} \qquad ( 1 )$$

Both i and j in expression (1) are variables representing a spin. In addition, sᵢ in expression (1) is a variable representing the state of spin i, and sⱼ is a variable representing the state of spin j. hᵢ in expression (1) is a constant corresponding to spin i. For each possible value of i, hᵢ is determined as a constant. Jᵢⱼ in expression (1) is a constant corresponding to a combination of spin i and spin j. For each combination of possible value of i and possible value of j, Jᵢⱼ is determined as a constant.

QUBO is a model in which the states of individual spins are represented by “1” or “0”.

The energy function of QUBO is expressed as in expression (2) below.

$$[ Math . 2 ]$$

$$E = {\sum }_{i} {\sum }_{j} {Q}_{ij} {s}_{i} {s}_{j} \qquad ( 2 )$$

Both i and j in expression (2) are variables representing a spin. In addition, sᵢ in expression (2) is a variable representing the state of spin i, and sⱼ is a variable representing the state of spin j. Qᵢⱼ in expression (2) is a constant corresponding to a combination of spin i and spin j. For each combination of possible value of i and possible value of j, Qᵢⱼ is determined as a constant.

The energy function of the Ising model or QUBO is input to a solution device that performs simulated annealing. The solution device uses simulated annealing to obtain the state of each spin that corresponds to the solution of a combinatorial optimization problem.

The following explanation uses the case of obtaining the energy function of QUBO as an example. However, obtaining the energy function of the Ising model can also be explained in the same way as described below.

The energy function of QUBO is obtained by transforming an expression representing energy in a combinatorial optimization problem. This expression represents weighted sum of one or more objective functions and one or more constraint terms as energy. One constraint term represents one constraint. Each of the one or more objective functions and each of the one or more constraint terms has a defined weight coefficient. Each individual objective function and each individual constraint term can be transformed by itself into the form of the energy function of QUBO.

For example, expression (3) below is an example of an expression representing energy in a combinatorial optimization problem.

$$E = {W}_{1} ( objective function 1 ) + {W}_{2} ( objective function 2 ) + {W}_{3} ( constraint term 1 ) + {W}_{4} ( constraint term 2 ) + {W}_{5} ( constraint term 3 + constraint term 4 ) \qquad ( 3 )$$

W₁, W₂, W₃, W₄, and W₅ are weight coefficients, respectively.

In expression (3), W₅ (constraint term 3+constraint term 4) represents that multiple constraint terms (constraint term 3 and constraint term 4) are associated with a common weight coefficient W₅.

The expression representing energy as exemplified in expression (3) is transformed into the energy function of QUBO. The energy function of QUBO is then input to the solution device. The solution device obtains the state of each spin that corresponds to the solution of the combinatorial optimization problem.

The following is a specific example of the expression representing energy that is transformed into the energy function of QUBO. Here, the traveling salesman problem when the number of cities is four is exemplified. FIG. 7 is a schematic diagram showing an example of the state of each spin in this traveling salesman problem. In this example, the expression representing energy is expressed as shown below in expression (4).

$$[ Math . 3 ]$$

$$E = {\sum }_{i} {\sum }_{j} {d}_{ij} {s}_{i} {s}_{j} + {A ( {\sum }_{j = 0}^{3} {s}_{j} - 1 )}^{2} + {A ( {\sum }_{j = 0}^{3} {s}_{4 + j} - 1 )}^{2} + {A ( {\sum }_{j = 0}^{3} {s}_{8 + j} - 1 )}^{2} + {A ( {\sum }_{j = 0}^{3} {s}_{12 + j} - 1 )}^{2} + {A ( {\sum }_{i = 0}^{3} {s}_{4 * i} - 1 )}^{2} + {A ( {\sum }_{i = 0}^{3} {s}_{4 * i + 1} - 1 )}^{2} + {A ( {\sum }_{i = 0}^{3} {s}_{4 * i + 2} - 1 )}^{2} + {A ( {\sum }_{i = 0}^{3} {s}_{4 * i + 3} - 1 )}^{2} \qquad ( 4 )$$

The first term on the right side of expression (4) is the objective function. In this example, the weight coefficient of the objective function is 1. The dᵢⱼ in the objective function represents the distance between two cities. The second through ninth terms on the right side of expression (4) are constraint terms. Each constraint term has a common weight coefficient A. The objective function in this example is in the form of the energy function of QUBO. Also, each of the eight constraint terms can be transformed by itself into the form of the energy function of QUBO.

The second term on the right side is the constraint that only one spin is 1 in the first column shown in FIG. 7. The third term on the right side is the constraint that only one spin is 1 in the second column shown in FIG. 7. The fourth term on the right side is the constraint that only one spin is 1 in the third column shown in FIG. 7. The fifth term on the right side is the constraint that only one spin is 1 in the fourth column shown in FIG. 7.

The sixth term on the right side is the constraint that only one spin is 1 in the first row shown in FIG. 7. The seventh term on the right side is the constraint that only one spin is 1 in the second row shown in FIG. 7. The eighth term on the right side is the constraint that only one spin is 1 in the third row shown in FIG. 7. The ninth term on the right side is the constraint that only one spin is 1 in the fourth row shown in FIG. 7.

The closer the value of a constraint term is to 0, the more satisfied the constraint which the constraint term represents.

In general, depending on the value of the weight coefficient of the constraint term, the solution obtained by the solution device may not satisfy the constraint represented by the constraint term. Therefore, the weight coefficients of the constraint terms are generally determined so that the solution satisfies the constraints by repeating simulated annealing and modifying the weight coefficients of the constraint terms. FIG. 8 is a flowchart showing an example of the general process of determining the weight coefficients of the constraint terms. It is assumed that the weight coefficients of the objective function are determined by the operator as fixed values.

First, the weight coefficients of each constraint term are initialized (step S101). Then, simulated annealing is performed to obtain a solution to the combinatorial optimization problem (step S102). Next, it is determined whether the solution satisfies the constraints indicated by each constraint term (step S103). When there are unsatisfied constraints in the obtained solution (No in step S103), the weight coefficients of the constraint terms are modified manually or automatically (step S104). Then, repeat the process from step S102 onward. When a solution is obtained that satisfies all the constraints indicated by each constraint term (Yes in step S103), then the weight coefficients of each constraint term obtained at that point are determined as the weight coefficients of each constraint term.

The weight coefficients of the objective functions may be determined by the operator as appropriate. For example, in the example shown in expression (3), when the operator determines that objective function 1 is important, the operator may set the weight coefficient W₁ of objective function 1 to a large value.

In addition, PTL 1 describes performing simulated annealing by defining energy functions separately for constraint terms representing constraints and for a cost term representing the cost function, and adjusting the values of the weight coefficients of the constraint terms by a parameter update rule.

### CITATION LIST

### Patent Literature

PTL 1: Japanese Patent Application Laid-Open No. H8-153085

### SUMMARY OF INVENTION

### Technical Problem

As mentioned above, when determining the weight coefficients of the constraint terms that can obtain a solution that satisfies the constraints by repeating simulated annealing and modifying the weight coefficients of the constraint terms, the simulated annealing is repeated. Therefore, this method takes time to determine the weight coefficients of the constraint terms.

Therefore, the purpose of the present invention is to provide a weight coefficient calculation device, a weight coefficient calculation method, and a computer-readable recording medium containing a weight coefficient calculation program that can rapidly calculate weight coefficients of constraint terms in an expression representing energy in a combinatorial optimization problem.

### Solution to Problem

A weight coefficient calculation device according to the present invention includes: input means in which each constraint term in an expression representing energy in a combinatorial optimization problem is input; automatic establishment rate calculation means for calculating an automatic establishment rate for each constraint term, wherein the automatic establishment rate is a probability that a constraint represented by a constraint term is satisfied when all other constraints associated with individual spins associated with the constraint term are satisfied; energy increase amount determination means for determining amount of energy increase at constraint breakdown for each constraint term, wherein the amount of energy increase at constraint breakdown is amount of energy increase when a constraint represented by a constraint term is no longer satisfied; spin number derivation means for deriving the number of spins associated with a constraint represented by a constraint term, for each constraint term; and weight coefficient calculation means for calculating a weight coefficient corresponding to a constraint term based on the automatic establishment rate, the amount of energy increase at constraint breakdown and the number of spins, for each constraint term.

A weight coefficient calculation method according to the present invention is characterized in that, a computer, receives input of each constraint term in an expression representing energy in a combinatorial optimization problem, executes an automatic establishment rate calculation process of calculating an automatic establishment rate for each constraint term, wherein the automatic establishment rate is a probability that a constraint represented by a constraint term is satisfied when all other constraints associated with individual spins associated with the constraint term are satisfied; executes an energy increase amount determination process of determining amount of energy increase at constraint breakdown for each constraint term, wherein the amount of energy increase at constraint breakdown is amount of energy increase when a constraint represented by a constraint term is no longer satisfied; executes a spin number derivation process of deriving the number of spins associated with a constraint represented by a constraint term, for each constraint term; and executes a weight coefficient calculation process of calculating a weight coefficient corresponding to a constraint term based on the automatic establishment rate, the amount of energy increase at constraint breakdown and the number of spins, for each constraint term.

A computer-readable recording medium according to the present invention is a computer-readable recording medium in which a weight coefficient calculation program is recorded, wherein the weight coefficient calculation program causes a computer comprising input means in which each constraint term in an expression representing energy in a combinatorial optimization problem is input to execute: an automatic establishment rate calculation process of calculating an automatic establishment rate for each constraint term, wherein the automatic establishment rate is a probability that a constraint represented by a constraint term is satisfied when all other constraints associated with individual spins associated with the constraint term are satisfied; an energy increase amount determination process of determining amount of energy increase at constraint breakdown for each constraint term, wherein the amount of energy increase at constraint breakdown is amount of energy increase when a constraint represented by a constraint term is no longer satisfied; a spin number derivation process of deriving the number of spins associated with a constraint represented by a constraint term, for each constraint term; and a weight coefficient calculation process of calculating a weight coefficient corresponding to a constraint term based on the automatic establishment rate, the amount of energy increase at constraint breakdown and the number of spins, for each constraint term.

### Advantageous Effects of Invention

According to the present invention, weight coefficients of constraint terms in an expression representing energy in a combinatorial optimization problem can be calculated rapidly.

### BRIEF DESCRIPTION OF DRAWING

FIG. 1 It depicts a block diagram showing a configuration example of a weight coefficient calculation device of the example embodiment of the present invention.

FIG. 2 It depicts a schematic diagram showing an example of constraints defined for multiple spins.

FIG. 3 It depicts a schematic diagram showing the amount of energy increase when the number of spins that are 1 decreases by 1 from n−a and the amount of energy increase when the number of spins that are 1 increases by 1 from n+b.

FIG. 4 It depicts a flowchart showing an example of the processing flow of the example embodiment of the present invention.

FIG. 5 It depicts a schematic block diagram showing an example of a computer configuration of the weight coefficient calculation device of the example embodiment of the present invention.

FIG. 6 It depicts a block diagram showing an overview of the weight coefficient calculation device of the present invention.

FIG. 7 It depicts a schematic diagram showing an example of the state of each spin in the traveling salesman problem.

FIG. 8 It depicts a flowchart showing an example of the general process of determining the weight coefficients of the constraint terms.

### DESCRIPTION OF EMBODIMENTS

An example embodiment of the present invention is described below with reference to the drawings.

In the following explanation, the case of obtaining the energy function of QUBO from the expression representing energy of a combinatorial optimization problem will be used as an example. However, the same applies to the case of obtaining the energy function of the Ising model.

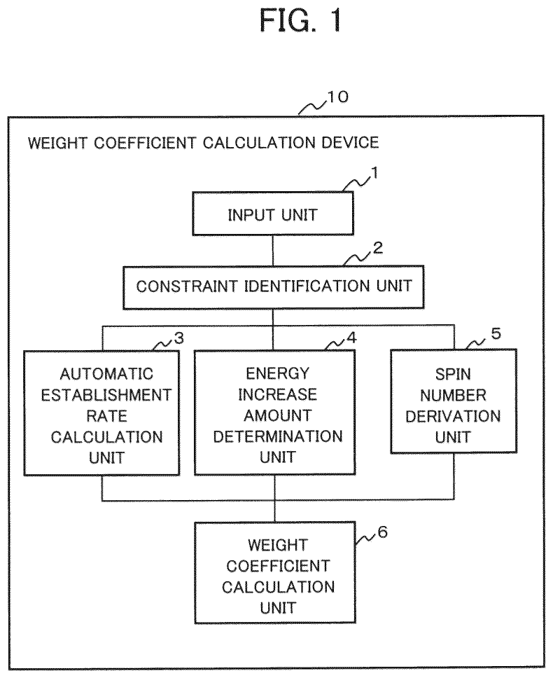

FIG. 1 is a block diagram showing a configuration example of a weight coefficient calculation device of the example embodiment of the present invention. The weight coefficient calculation device 10 of the example embodiment includes an input unit 1, a constraint identification unit 2, an automatic establishment rate calculation unit 3, an energy increase amount determination unit 4, a spin number derivation unit 5, and a weight coefficient calculation unit 6.

Each objective function and each constraint term in the expression representing energy of a combinatorial optimization problem that is transformed into energy function of QUBO are input to the input unit 1. The number of constraint terms to be input is one or more. The weight coefficients of the objective functions may be determined by the operator as appropriate, so the objective functions need not be input.

When there are multiple constraint terms associated with a common weight coefficient, information specifying the multiple constraint terms is also input to the input unit 1. There may be more than one set of multiple constraint terms associated with a common weight coefficient.

As already explained, one constraint term represents one constraint.

Each objective function and each constraint term input to the input unit 1 can, by itself, be transformed into the form of the energy function of QUBO.

The input unit 1 is an input device to which each objective function, each constraint term, and the information specifying the multiple constraint terms when the multiple constraint terms associated with the common weight coefficients exist, is input. For example, the input unit 1 may be an input device such as a data reading device that reads each objective function, each constraint term, and the information specifying the multiple constraint terms when the multiple constraint terms associated with the common weight coefficients exist, recorded on a recording medium. However, as described above, the objective functions need not be input to the input unit 1.

The constraint identification unit 2 identifies, for each input constraint term, content of the constraint that the constraint term represents.

The automatic establishment rate calculation unit 3 calculates an automatic establishment rate for each constraint (in other words, for each constraint term). The automatic establishment rate is a probability that a constraint represented by a constraint term is satisfied when all other constraints associated with individual spins associated with the constraint term are satisfied.

The association between the spin and the constraint means that the state of the spin is referenced in determining whether the constraint is satisfied or not.

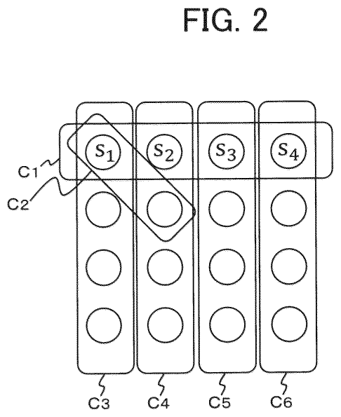

FIG. 2 is a schematic diagram showing an example of constraints defined for multiple spins. The content of each constraint C₁ to C₆ is identified by the constraint identification unit 2 based on each input constraint term. In this example, it is assumed that constraints C₁ to C₆ are all constraints that only one spin is 1. Hereafter, the constraint that only one spin is 1 is referred to as the one-hot constraint.

The automatic establishment rate of constraint C₁ is used as an example, for explanation. The individual spins associated with constraint C₁ are spins 1 through 4 (see FIG. 2). All other constraints associated with that individual spin are constraints C₂, C₃ associated with spin 1, C₄ associated with spin 2, C₅ associated with spin 3, and C₆ associated with spin 4 (see FIG. 2). Thus, the automatic establishment rate of constraint C₁ is the probability that constraint C₁ is satisfied when constraints C₂ to C₆ are all satisfied.

The automatic establishment rate calculation unit 3 calculates the automatic establishment rate as a value in the range between 0 and 1.

Hereafter, the constraint for which the automatic establishment rate is calculated is referred to as the target constraint. All other constraints associated with each spin associated with the target constraint are also referred to as associated constraints. When calculating the automatic establishment rate of the target constraint, the automatic establishment rate calculation unit 3 calculates a probability that a spin is 1 for each spin associated with the target constraint, assuming that all the associated constraints are satisfied. The automatic establishment rate calculation unit 3 calculates the automatic establishment rate of the target constraint based on the probabilities of each spin being 1.

FIG. 2 is used for a concrete explanation. It is assumed that the target constraint is constraint C₁. In this case, constraints C₂ to C₆ are the associated constraints. The automatic establishment rate calculation unit 3 calculates the probability of spin 1 being 1 (the probability that s₁=1), spin 2 being 1 (the probability that s₂=1), spin 3 being 1 (the probability that s₃=1), and spin 4 being 1 (the probability that s₄=1) when the associated constraints C₂ to C₆ are all satisfied, respectively. Then, the automatic establishment rate calculation unit 3 calculates the automatic establishment rate of the target constraint based on the calculated probabilities above.

A concrete calculation example is shown below. The associated constraints C₂ to C₆ are assumed to be satisfied. The number of spins associated with constraint C₂ is 2. Therefore, the probability that s₁=1 when constraint C₂ is satisfied is ½=0.5. Also, the number of spins associated with constraint C₃ is 4. Therefore, the probability that s₁=1 when constraint C₃ is satisfied is ¼=0.25. The probability that s₁=1 when constraints C₂, C₃ are satisfied is the average of the above two probabilities, (0.5+0.25)/2=0.375.

Also, the number of spins associated with constraint C₄ is 4. Therefore, the probability that s₂=1 when constraint C₄ is satisfied is ¼=0.25. Similarly, the probability that s₃=1 when constraint C₅ is satisfied is 0.25. The probability that s₄=1 when constraint C₆ is satisfied is also 0.25.

In this example, the automatic establishment rate calculation unit 3 calculates the probability of a spin being 1 for each individual spin associated with the target constraint, as described above.

Next, the automatic establishment rate calculation unit 3 calculates the automatic establishment rate of the target constraint C₁ as follows. The target constraint C₁ is the one-hot constraint. Therefore, the automatic establishment rate calculation unit 3 first calculates the probability that s₁=1 and s₂=s₃=s₄=0. The automatic establishment rate calculation unit 3 calculates this probability to be 0.375*(1−0.25)³=0.1582.

Next, the automatic establishment rate calculation unit 3 calculates the probability that s₂=1 and s₁=s₃=s₄=0. The automatic establishment rate calculation unit 3 calculates this probability to be (1−0.375)*0.25*(1−0.25)²=0.08789.

The automatic establishment rate calculation unit 3 also calculates the probability that s₃=1 and s₁=s₂=s₄=0, and the probability that s₄=1 and s₁=s₂=s₃=0 as 0.08789, respectively, in the same way as above.

Therefore, the automatic establishment rate calculation unit 3 calculates the probability that the target constraint C₁ (the one-hot constraint) is satisfied as 0.1582+0.08789+0.08789+0.08789=0.422.

By calculating the probability of a spin being 1 for each individual spin associated with the target constraint, the automatic establishment rate calculation unit 3 can calculate the automatic establishment rate even when the target constraint is an arbitrary constraint.

In the above explanation, the case where the target constraint is constraint C₁ is used as an example. As mentioned above, the automatic establishment rate calculation unit 3 calculates the automatic establishment rate for each constraint (for each constraint term).

In general, the larger the weight coefficient of a constraint term, the more likely the constraint the constraint term represents is to be satisfied. The smaller the weight coefficient of a constraint term, the less likely the constraint the constraint term represents is to be satisfied. Since a high automatic establishment rate means that the constraint is more likely to be satisfied, the constraint can be satisfied even when the weight coefficient is smaller. Therefore, the weight coefficient calculation unit 6, described below, determines the weight coefficient so that the larger the automatic establishment rate, which is a value between 0 and 1, the smaller the weight coefficient.

The energy increase amount determination unit 4 determines, for each constraint (in other words, for each constraint term), amount of energy increase at constraint breakdown. The amount of energy increase at constraint breakdown is amount of energy increase when a constraint represented by a constraint term is no longer satisfied.

However, the energy increase amount determination unit 4 calculates the amount of energy increase at constraint breakdown, with respect to the constraint “the number of spins that are 1 is equal to or greater than the first predetermined value and equal to or less than the second predetermined value”, the constraint “the number of spins that are 1 is equal to or greater than the predetermined value”, and the constraint “the number of spins that are 1 is equal to or less than the predetermined value”. For the other constraints, the energy increase amount determination unit 4 uniformly determines the amount of energy increase at constraint breakdown as “1”. The content of the constraint for each constraint term has been identified by the constraint identification unit 2.

The following is an example of the operation in which the energy increase amount determination unit 4 determines the amount of energy increase at constraint breakdown with respect to the constraint “the number of spins that are 1 is equal to or greater than the first predetermined value and equal to or less than the second predetermined value”. In the following, the number of spins that are 1 when the energy of the constraint term representing this constraint is minimized is n. Also, let the first predetermined value be n−a and the second predetermined value be n+b.

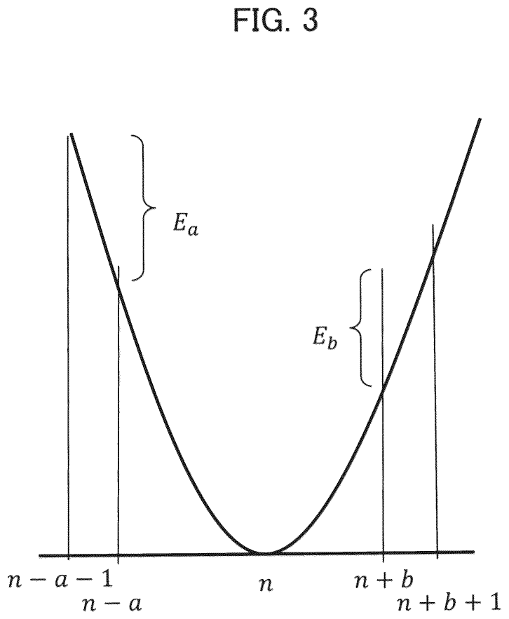

FIG. 3 is a schematic diagram showing the amount of energy increase when the number of spins that are 1 decreases by 1 from n−a and the amount of energy increase when the number of spins that are 1 increases by 1 from n+b. In the graph shown in FIG. 3, the horizontal axis indicates the number of spins that are 1 among the spins associated with the constraint. The vertical axis indicates the energy determined based on the constraint term representing the constraint.

As shown in FIG. 3, the amount of energy increase when the number of spins that are 1 decreases by 1 from n−a is denoted as Eₐ. The amount of energy increase when the number of spins that are 1 increases by 1 from n+b is denoted as E_{b}. The energy increase amount determination unit 4 can calculate the amount of energy increase Eₐ, E_{b} based on the constraint term representing this constraint.

For the constraint term under focus, the energy increase amount determination unit 4 calculates, for each individual spin associated with the constraint, the probability of a spin being 1 based on the other associated constraints, respectively. Based on the probabilities, the energy increase amount determination unit 4 calculates the probability that the number of spins that are 1 is less than n−a and the probability that the number of spins that are 1 is greater than n+b, respectively. The probability that the number of spins that are 1 is less than n−a is denoted as Pa. The probability that the number of spins that are 1 is greater than n+b is denoted as Pb.

The energy increase amount determination unit 4 determines the amount of energy increase at constraint breakdown in the constraint “the number of spins that are 1 is equal to or greater than the first predetermined value and equal to or less than the second predetermined value” by using Eₐ, E_{b}, Pa, Pb and the following expression (5).

$$( {E}_{a} - {E}_{b} ) * {P}_{a} / ( {P}_{a} + {P}_{b} ) + {E}_{b} \qquad ( 5 )$$

The value obtained by expression (5) is the amount of energy increase at constraint breakdown in the constraint “the number of spins that are 1 is equal to or greater than the first predetermined value and equal to or less than the second predetermined value”.

When the probability Pa is 0, the energy increase amount determination unit 4 determines the amount of energy increase at constraint breakdown to be E_{b}.

When the probability Pb is 0, the energy increase amount determination unit 4 determines the amount of energy increase at constraint breakdown to be Eₐ.

For the constraint “the number of spins that are 1 is equal to or greater than the predetermined value”, the energy increase amount determination unit 4 determines the amount of energy increase when the number of spins that are 1 changes from the predetermined value to 1 less than the predetermined value as the amount of energy increase at constraint breakdown.

For the constraint “the number of spins that are 1 is equal to or less than the predetermined value”, the energy increase amount determination unit 4 determines the amount of energy increase when the number of spins that are 1 changes from the predetermined value to 1 more than the predetermined value as the amount of energy increase at constraint breakdown.

The constraint represented by the constraint term with large amount of energy increase at constraint breakdown are more likely to be satisfied when simulated annealing is performed. Therefore, even when the weight coefficient is reduced for the constraint terms with the large amount of energy increase at constraint breakdown, the constraint represented by the constraint term can be satisfied. Therefore, the weight coefficient calculation unit 6, described below, determines the weight coefficient so that the larger the amount of energy increase at constraint breakdown, the smaller the weight coefficient.

The spin number derivation unit 5 derives the number of spins associated with a constraint, for each constraint (in other words, for each constraint term). Based on the constraint term, the spin number derivation unit 5 may derive the number of spins associated with the constraint that the constraint term represents.

The greater the number of spins associated with a constraint, the higher the probability that a spin associated with that constraint is selected and flipped during a simulated annealing run. As a result, the constraint is more likely to be satisfied. Therefore, the greater the number of spins associated with the constraint, the more likely the constraint can be satisfied even when the weight coefficient is reduced. Therefore, the weight coefficient calculation unit 6, described below, determines the weight coefficient so that the greater the number of spins associated with the constraint, the smaller the weight coefficient.

The weight coefficient calculation unit 6 calculates a weight coefficient corresponding to a constraint term for each constraint (in other words, for each constraint term). The weight coefficient calculation unit 6 calculates the weight coefficient corresponding to the constraint term under focus based on the automatic establishment rate, the amount of energy increase at constraint breakdown, and the number of spins obtained for the constraint term.

As mentioned above, the weight coefficient calculation unit 6 determines the weight coefficient so that the larger the automatic establishment rate, which is a value between 0 and 1, the smaller the weight coefficient. The weight coefficient calculation unit 6 determines the weight coefficient so that the larger the amount of energy increase at constraint breakdown, the smaller the weight coefficient. The weight coefficient calculation unit 6 determines the weight coefficient so that the greater the number of spins associated with the constraint, the smaller the weight coefficient.

Specifically, the weight coefficient calculation unit 6 calculates a weight coefficient corresponding a constraint term, for each constraint term, by calculating the following expression (6).

weight coefficient=(1−automatic establishment rate)/(amount of energy increase at constraint breakdown*the number of spins) (6)

When there are multiple constraint terms associated with a common weight coefficient, the weight coefficient calculation unit 6 determines the average value of the weight coefficients calculated in expression (6) for each of the multiple constraint terms as the common weight coefficient associated with the multiple constraint terms.

For example, it is assumed that constraint term 1, constraint term 2, constraint term 3, and constraint term 4 shown in expression (3) are input, and information specifying constraint terms 3 and 4 as multiple constraint terms associated with a common weight coefficient is input. In this case, the weight coefficient calculation unit 6 determines the value calculated by expression (6) for constraint term 1 as the weight coefficient W₃ corresponding to constraint term 1. Similarly, the weight coefficient calculation unit 6 determines the value calculated by expression (6) for constraint term 2 as the weight coefficient W₄ corresponding to constraint term 2. When determining the weight coefficient W₅ common to constraint term 3 and constraint term 4, the weight coefficient calculation unit 6 calculates the average value of the weight coefficient calculated by expression (6) for constraint term 3 and the weight coefficient calculated by expression (6) for constraint term 4, and determines that average value as the weight coefficient W₅.

The constraint identification unit 2, the automatic establishment rate calculation unit 3, the energy increase amount determination unit 4, the spin number derivation unit 5, and the weight coefficient calculation unit 6 are realized, for example, by a CPU (Central Processing Unit) of a computer operating according to a weight coefficient calculation program. For example, the CPU may read the weight coefficient calculation program from a program storage medium such as a program storage device of the computer and operate as the constraint identification unit 2, the automatic establishment rate calculation unit 3, the energy increase amount determination unit 4, the spin number derivation unit 5, and the weight coefficient calculation unit 6 according to the weight coefficient calculation program.

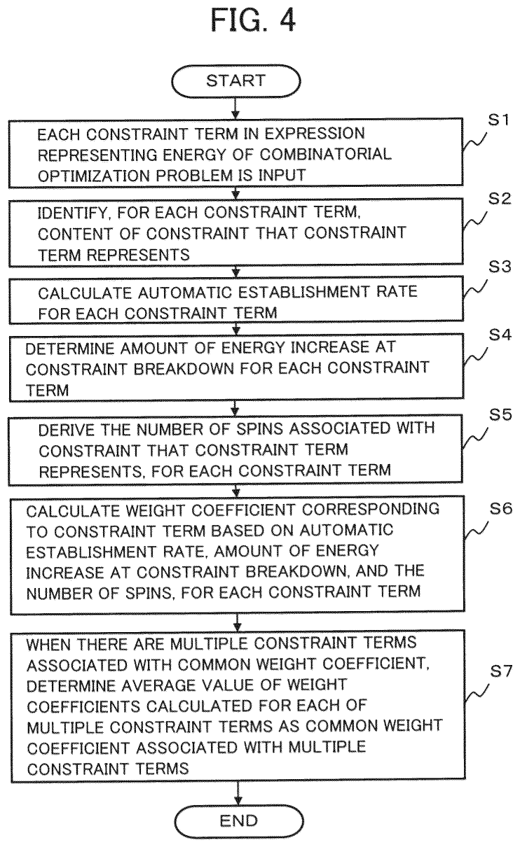

Next, the processing flow is described. FIG. 4 is a flowchart showing an example of the processing flow of the present example embodiment. Detailed explanations of matters already explained are omitted.

First, each constraint term in the expression representing the energy of a combinatorial optimization problem is input to input unit 1 (step S1). In step S1, each objective function in the expression representing the energy may also be input to the input unit 1. When there are multiple constraint terms associated with a common weight coefficient, information specifying the multiple constraint terms is also input to input unit 1.

Next, the constraint identification unit 2 identifies, for each constraint term, the content of the constraint that the constraint term represents (step S2).

Next, the automatic establishment rate calculation unit 3 calculates the automatic establishment rate for each constraint term (step S3).

The energy increase amount determination unit 4 determines the amount of energy increase at constraint breakdown for each constraint term (step S4).

The spin number derivation unit 5 derives the number of spins associated with the constraint that the constraint term represents, for each constraint term (step S5).

The order of execution of steps S3, S4, and S5 is not limited. The automatic establishment rate calculation unit 3, the energy increase amount determination unit 4, and the spin number derivation unit 5 may execute steps S3, S4, and S5 in parallel.

Next, the weight coefficient calculation unit 6 calculates the weight coefficient corresponding to the constraint term based on the automatic establishment rate, the amount of energy increase at constraint breakdown, and the number of spins, for each constraint term (step S6).

When there are multiple constraint terms associated with a common weight coefficient, the weight coefficient calculation unit 6 determines the average value of the weight coefficients calculated for each of the multiple constraint terms as the common weight coefficient associated with the multiple constraint terms (step S7). When there is no multiple constraint terms associated with a common weight coefficient, the weight coefficient calculation unit 6 may terminate the process at step S6 without performing step S7.

The weight coefficient calculation unit 6 may display the individual weight coefficients corresponding to the individual constraint terms finally determined, for example, on a display device (not shown). However, the output manner of the individual weight coefficients corresponding to the individual constraint terms is not limited to the above example.

According to the present example embodiment, each constraint term in the expression representing the energy of a combinatorial optimization problem is input to the weight coefficient calculation device 10. When there are multiple constraint terms associated with a common weight coefficient, information specifying the multiple constraint terms is also input to the weight coefficient calculation device 10. The weight coefficient calculation device 10 calculates the weight coefficients corresponding to each of the input constraint terms based on the input information. The weight coefficient calculation device 10 calculates the weight coefficients so that the weight coefficients are smaller for the constraint terms that represent constraints that are easy to satisfy. Generally, when the weight coefficient of a constraint term is smaller, the constraint represented by that constraint term is less likely to be satisfied. However, the weight coefficient calculation device 10 of the present example embodiment calculates the weight coefficients so that the weight coefficients become smaller for constraint terms that represent constraints that are easy to satisfy, so the constraints can be satisfied even when the weight coefficients are small.

As described above, the weight coefficient calculation device 10 calculates the weight coefficients corresponding to each input constraint term based on the input information, so the weight coefficients of each constraint term can be calculated without the iterative process involving simulated annealing (see FIG. 8). Therefore, the weight coefficients of each constraint term in the expression representing the energy of the combinatorial optimization problem can be calculated rapidly.

Each objective function and each constraint term in the expression representing the energy of a combinatorial optimization problem are predetermined according to the combinatorial optimization problem. The weight coefficients of each constraint term are then determined by the weight coefficient calculation device 10 of the present example embodiment. The operator may also determine the weight coefficients of each objective function as appropriate. As a result, each objective function and each constraint term, as well as the weight coefficients of each objective function and each constraint term, are determined. In other words, the expression representing the energy is determined. Therefore, the expression representing the energy can be transformed into an energy function of QUBO, and by inputting the energy function to the solution device that performs simulated annealing, the state of each spin that corresponds to the solution of the combinatorial optimization problem can be obtained.

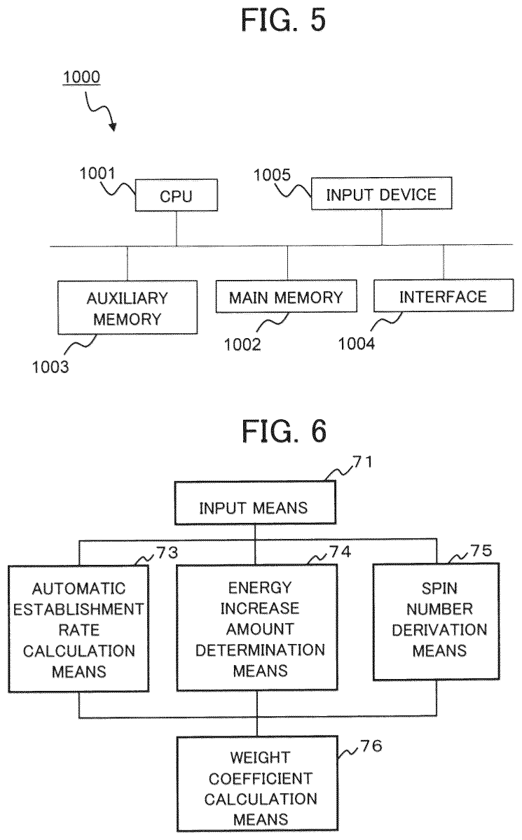

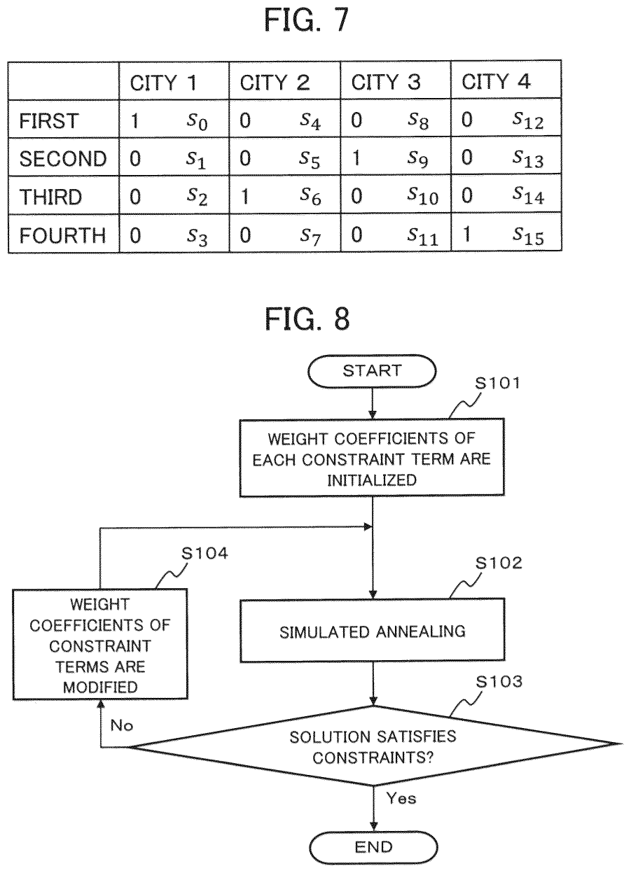

FIG. 5 is a schematic block diagram showing an example of a computer configuration of the weight coefficient calculation device of the example embodiment of the present invention. The computer 1000 includes a CPU 1001, a main memory 1002, an auxiliary memory 1003, an interface 1004, and an input device 1005.

The weight coefficient calculation device 10 of the example embodiment of the present invention is realized by a computer 1000. The operation of the weight coefficient calculation device 10 is stored in the auxiliary memory 1003 in the form of a weight coefficient calculation program. The CPU 1001 reads the weight coefficient calculation program from the auxiliary memory 1003, expands the weight coefficient calculation program into the main memory 1002, and executes the processes described in the above example embodiment according to the weight coefficient calculation program.

The auxiliary memory 1003 is an example of a non-transitory tangible medium. Other examples of non-transitory tangible media include magnetic disks, magneto-optical disks, CD-ROM (Compact Disk Read Only Memory), DVD-ROM (Digital Versatile Disk Read Only Memory), semiconductor memory, etc., connected via interface 1004. When the program is delivered to the computer 1000 through a communication line, the computer 1000 receiving the delivery may expand the program into the main memory 1002 and execute the processes described in the above example embodiment according to the program.

Some or all of the components may be realized by general-purpose or dedicated circuitry, processor, or a combination of these. These may comprise a single chip or multiple chips connected via a bus. Some or all of each component may be realized by a combination of the above-mentioned circuitry, etc. and a program.

When some or all of each component are realized by multiple information processing devices, circuits, etc., the multiple information processing devices, circuits, etc. may be centrally located or distributed. For example, the information processing devices and circuits may be realized as a client-and-server system, a cloud computing system, etc., each of which is connected via a communication network.

The following is an overview of the present invention. FIG. 6 is a block diagram showing an overview of the weight coefficient calculation device of the present invention. The weight coefficient calculation device of the present invention includes input means 71, automatic establishment rate calculation means 73, energy increase amount determination means 74, spin number derivation means 75, and weight coefficient calculation means 76.

Each constraint term in an expression representing energy in a combinatorial optimization problem is input the input means 71 (e.g., the input unit 1).

The automatic establishment rate calculation means 73 (e.g., the automatic establishment rate calculation unit 3) calculates an automatic establishment rate for each constraint term, wherein the automatic establishment rate is a probability that a constraint represented by a constraint term is satisfied when all other constraints associated with individual spins associated with the constraint term are satisfied.

The energy increase amount determination means 74 (e.g., the energy increase amount determination unit 4) determines amount of energy increase at constraint breakdown for each constraint term, wherein the amount of energy increase at constraint breakdown is amount of energy increase when a constraint represented by a constraint term is no longer satisfied.

The spin number derivation means 75 (e.g., the spin number derivation unit 5) derives the number of spins associated with a constraint represented by a constraint term, for each constraint term.

The weight coefficient calculation means 76 (e.g., the weight coefficient calculation unit 6) calculates a weight coefficient corresponding to a constraint term based on the automatic establishment rate, the amount of energy increase at constraint breakdown and the number of spins, for each constraint term.

According to such a configuration, weight coefficients of constraint terms in an expression representing energy in a combinatorial optimization problem can be calculated rapidly.

The automatic establishment rate calculation means 73 may calculate a probability of each spin associated with a constraint represented by a constraint term being 1 when all other constraints associated with individual spins associated with the constraint term are satisfied, and calculate the automatic establishment rate based on the probabilities of each spin being 1, for each constraint term.

When there are multiple constraint terms associated with a common weight coefficient, the weight coefficient calculation means 76 may determine an average value of weight coefficients calculated for each of the multiple constraint terms as the common weight coefficient associated with the multiple constraint terms.

Although the present invention has been described above with reference to the example embodiment, the present invention is not limited to the above example embodiment. Various changes can be made to the configuration and details of the present invention that can be understood by those skilled in the art within the scope of the present invention.

### INDUSTRIAL APPLICABILITY

The present invention is suitably applied to a weight coefficient calculation device that calculates a weight coefficient of each constraint term in an expression representing energy in a combinatorial optimization problem.

### REFERENCE SIGNS LIST

1 Input unit
2 Constraint identification unit
3 Automatic establishment rate calculation unit
4 Energy increase amount determination unit
5 Spin number derivation unit
6 Weight coefficient calculation unit
10 Weight coefficient calculation device

What is claimed is:

1. A weight coefficient calculation device comprising:
input device in which each constraint term in an expression representing energy in a combinatorial optimization problem is input;
a memory configured to store instructions; and
a processor configured to execute the instructions to:
calculate an automatic establishment rate for each constraint term, wherein the automatic establishment rate is a probability that a constraint represented by a constraint term is satisfied when all other constraints associated with individual spins associated with the constraint term are satisfied;
determine amount of energy increase at constraint breakdown for each constraint term, wherein the amount of energy increase at constraint breakdown is amount of energy increase when a constraint represented by a constraint term is no longer satisfied;
derive the number of spins associated with a constraint represented by a constraint term, for each constraint term; and
calculate a weight coefficient corresponding to a constraint term based on the automatic establishment rate, the amount of energy increase at constraint breakdown and the number of spins, for each constraint term.

2. The weight coefficient calculation device according to claim 1,
wherein the processor calculates a probability of each spin associated with a constraint represented by a constraint term being 1 when all other constraints associated with individual spins associated with the constraint term are satisfied, and calculates the automatic establishment rate based on the probabilities of each spin being 1, for each constraint term.

3. The weight coefficient calculation device according to claim 1,
wherein when there are multiple constraint terms associated with a common weight coefficient, the processor determines an average value of weight coefficients calculated for each of the multiple constraint terms as the common weight coefficient associated with the multiple constraint terms.

4. A weight coefficient calculation method characterized in that,
a computer,
receives input of each constraint term in an expression representing energy in a combinatorial optimization problem,
executes an automatic establishment rate calculation process of calculating an automatic establishment rate for each constraint term, wherein the automatic establishment rate is a probability that a constraint represented by a constraint term is satisfied when all other constraints associated with individual spins associated with the constraint term are satisfied;
executes an energy increase amount determination process of determining amount of energy increase at constraint breakdown for each constraint term, wherein the amount of energy increase at constraint breakdown is amount of energy increase when a constraint represented by a constraint term is no longer satisfied;
executes a spin number derivation process of deriving the number of spins associated with a constraint represented by a constraint term, for each constraint term; and
executes a weight coefficient calculation process of calculating a weight coefficient corresponding to a constraint term based on the automatic establishment rate, the amount of energy increase at constraint breakdown and the number of spins, for each constraint term.

5. The weight coefficient calculation method according to claim 4,
wherein, in the automatic establishment rate calculation process, the computer calculates a probability of each spin associated with a constraint represented by a constraint term being 1 when all other constraints associated with individual spins associated with the constraint term are satisfied, and calculates the automatic establishment rate based on the probabilities of each spin being 1, for each constraint term.

6. The weight coefficient calculation method according to claim 4,
wherein, in the weight coefficient calculation process, when there are multiple constraint terms associated with a common weight coefficient, the computer determines an average value of weight coefficients calculated for each of the multiple constraint terms as the common weight coefficient associated with the multiple constraint terms.

7. A non-transitory computer-readable recording medium in which a weight coefficient calculation program is recorded, wherein the weight coefficient calculation program causes a computer comprising input device in which each constraint term in an expression representing energy in a combinatorial optimization problem is input to execute:
an automatic establishment rate calculation process of calculating an automatic establishment rate for each constraint term, wherein the automatic establishment rate is a probability that a constraint represented by a constraint term is satisfied when all other constraints associated with individual spins associated with the constraint term are satisfied;
an energy increase amount determination process of determining amount of energy increase at constraint breakdown for each constraint term, wherein the amount of energy increase at constraint breakdown is amount of energy increase when a constraint represented by a constraint term is no longer satisfied;
a spin number derivation process of deriving the number of spins associated with a constraint represented by a constraint term, for each constraint term; and
a weight coefficient calculation process of calculating a weight coefficient corresponding to a constraint term based on the automatic establishment rate, the amount of energy increase at constraint breakdown and the number of spins, for each constraint term.

8. The non-transitory computer-readable recording medium in which the weight coefficient calculation program is recorded, according to claim 7,
wherein the weight coefficient calculation program causes the computer to execute, in the automatic establishment rate calculation process,
calculating a probability of each spin associated with a constraint represented by a constraint term being 1 when all other constraints associated with individual spins associated with the constraint term are satisfied, and calculating the automatic establishment rate based on the probabilities of each spin being 1, for each constraint term.

9. The non-transitory computer-readable recording medium in which the weight coefficient calculation program is recorded, according to claim 7,
wherein the weight coefficient calculation program causes the computer to execute, in the weight coefficient calculation process,
when there are multiple constraint terms associated with a common weight coefficient, determining an average value of weight coefficients calculated for each of the multiple constraint terms as the common weight coefficient associated with the multiple constraint terms.
